(19) United States
(12) Patent Application Publication
(10) Pub. No.: US 2023/0402226 A1
(43) Pub. Date: Dec. 14, 2023

(54) TRANSFORMER WITH CONTROLLED LEAKAGE INDUCTANCE

(71) Applicant: VISHAY DALE ELECTRONICS, LLC, COLUMBUS, NE (US)

(72) Inventors: Matt Foley, Berwick, ME (US); Gary Bates, Chichester, NH (US); Garrett Caisse, Danville, NH (US); Jason Ebner, Barrington, NH (US)

(73) Assignee: VISHAY DALE ELECTRONICS, LLC, COLUMBUS, NE (US)

(21) Appl. No.: 18/140,742

(22) Filed: Apr. 28, 2023

Related U.S. Application Data
(60) Provisional application No. 63/344,819, filed on May 23, 2022.

(51) Int. Cl. H01F 27/34; H01F 27/24; H01F 27/30; H01F 27/32; H01F 41/02; H01F 41/04; H01F 27/28

(52) U.S. Cl. CPC H01F 27/346; H01F 27/24; H01F 27/306; H01F 27/2823; H01F 41/0206; H01F 41/04; H01F 27/325

(57) ABSTRACT

A multi-leg transformer includes a core having a plurality of center posts, a primary coil wound around at least one of the center posts, a secondary coil wound around at least one of the center posts and spaced apart from the primary coil, and at least one magnetic shunt material disposed in one or more selected areas between the primary coil and the secondary coil.

### CROSS-REFERENCE TO RELATED APPLICATION

This patent application claims the priority benefit under 35 U.S.C. § 119(e) of U.S. Provisional Application No. 63/344,819, filed on May 23, 2022, the contents of which are herein incorporated by reference.

### FIELD OF THE INVENTION

The disclosed concept relates generally to electrical components, and more particularly, to transformers.

### BACKGROUND OF THE INVENTION

Transformers face numerous design challenges. For example, in higher power transformer applications cooling is a concern. As another example, in transformers used in LLC applications the size of the core gaps and fringing flux are concerns. Additionally, the leakage inductance of transformers affects the suitability of transformers in certain applications and is compensated for by use of an additional inductor. There remains room for improvement in transformers.

### SUMMARY OF THE INVENTION

According to an aspect of the disclosed concept, a multi-leg transformer comprises: a core having a plurality of center posts; a primary coil wound around at least one of the center posts; a secondary coil wound around at least one of the center posts and spaced apart from the primary coil; and at least one magnetic shunt material disposed in one or more selected areas between the primary coil and the secondary coil.

According to an aspect of the disclosed concept, a method of making a multi-leg transformer comprises: providing a core having one or more core legs, a primary coil wound around at least one of the core legs, and a secondary coil wound around at least one of the core legs and spaced apart from the primary coil; determining a desired level of leakage inductance of the multi-leg transformer; and tuning the multi-leg transformer to the desired level of leakage inductance by placing at least one magnetic shunt material in one or more selected areas between the primary coil and the secondary coil.

According to an aspect of the disclosed concept, a bobbin for a multi-leg transformer having a core having a plurality of center posts, a primary coil wound around at least one of the center posts, a secondary coil wound around at least one of the center posts and spaced apart from the primary coil, and at least one magnetic shunt material disposed in one or more selected areas between the primary coil and the secondary coil comprises: a plurality of center portions corresponding to the plurality of center posts, each center portion structured to have a coil of the primary coil or secondary coil wound around it; at least one insulating barrier disposed between two of the plurality of center posts and structured to provide insulation between coils of the primary coil or the secondary coil; and at least one capture feature structured to assist the primary coil or secondary coil retain shape around the center posts.

### BRIEF DESCRIPTION OF THE DRAWINGS

A full understanding of the disclosed concept can be gained from the following description of the preferred embodiments when read in conjunction with the accompanying drawings in which:

FIG. 1A is an isometric view of a multi-leg transformer in accordance with an example embodiment of the disclosed concept;

FIG. 1B is a top view of the multi-leg transformer of FIG. 1A;

FIG. 1C is a front view of the multi-leg transformer of FIG. 1A;

FIG. 1D is a side view of the multi-leg transformer of FIG. 1A;

FIG. 2A is a top view of a multi-leg transformer in accordance with an example embodiment of the disclosed concept;

FIG. 2B is a cross-sectional view of the multi-leg transformer of FIG. 2A;

FIG. 3 is an exploded front view of a multi-leg transformer in accordance with an example embodiment of the disclosed concept;

FIG. 4 is an exploded isometric view of a multi-leg transformer in accordance with an example embodiment of the disclosed concept;

FIG. 5A is an isometric view of a lower core of a multi-leg transformer in accordance with an example embodiment of the disclosed concept;

FIG. 5B is a top view of the lower core of FIG. 5A;

FIG. 5C is a front view of the lower core of FIG. 5A;

FIG. 5D is a side view of the lower core of FIG. 5A;

FIG. 6A is an isometric view of a bobbin of a multi-leg transformer in accordance with an example embodiment of the disclosed concept;

FIG. 6B is a top view of the bobbin of FIG. 6A;

FIG. 6C is a front view of the bobbin of FIG. 6A;

FIG. 6D is a side view of the bobbin of FIG. 6A;

FIG. 7A is an isometric view of a winding of a multi-leg transformer in accordance with an example embodiment of the disclosed concept;

FIG. 7B is a front view of the winding of FIG. 7A; and

FIG. 7C is a side view of the winding of FIG. 7A.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the term “number” shall mean one or an integer greater than one (i.e., a plurality).

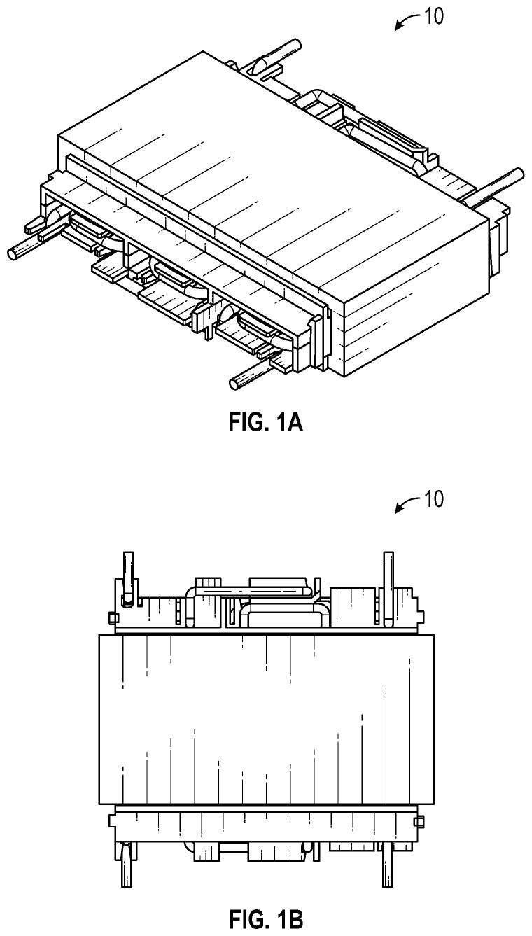

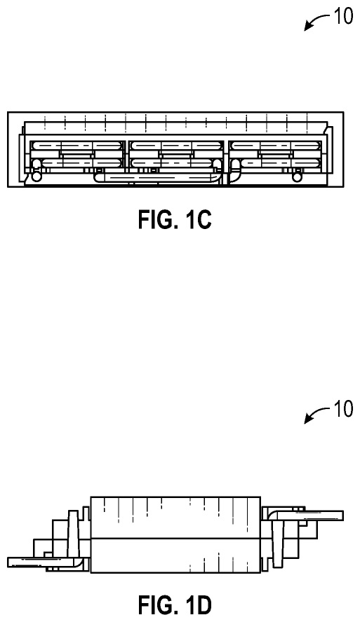

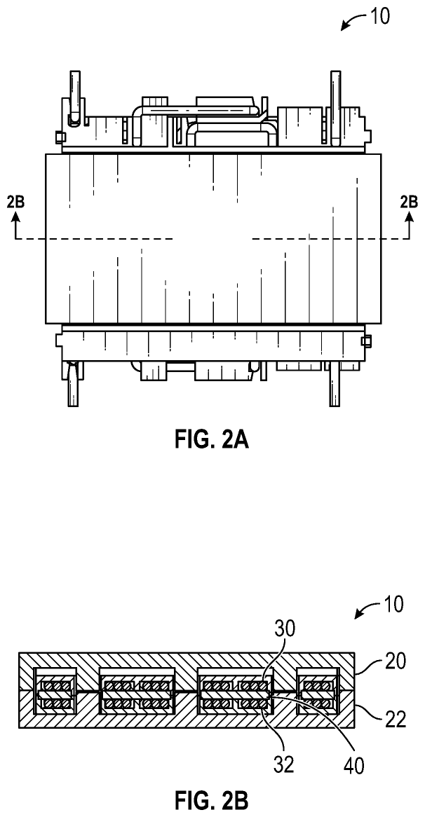

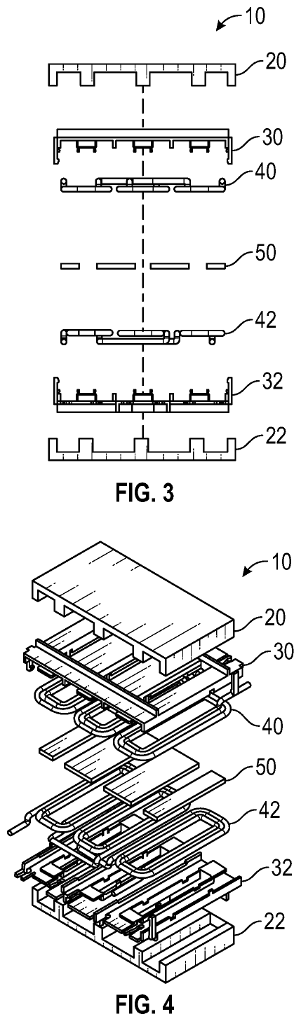

Various views of a multi-leg transformer 10 in accordance with an example embodiment of the disclosed concept are shown in FIGS. 1A-D. FIGS. 2A-B show additional views, including a cross-sectional view of the multi-leg transformer 10, and FIGS. 3 and 4 show exploded views of the multi-leg transformer 10.

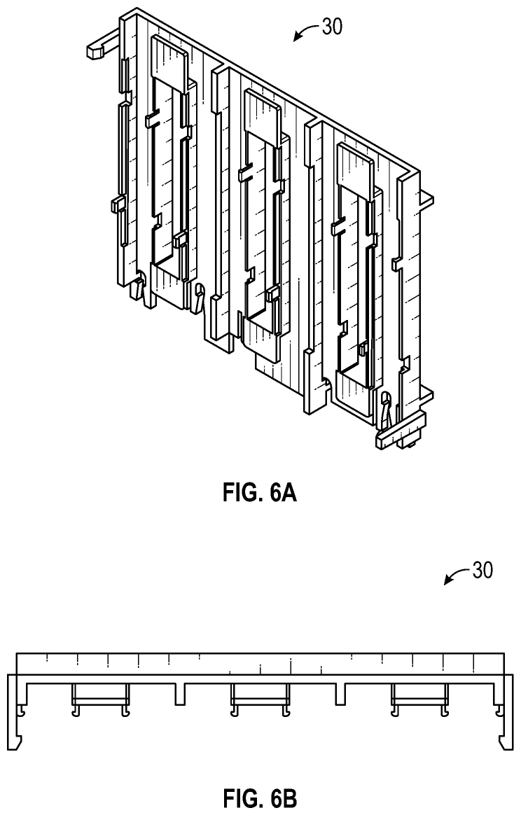

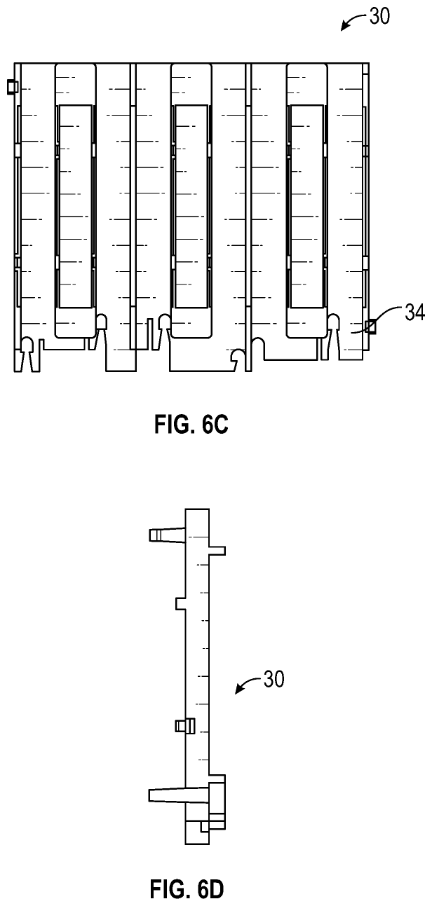

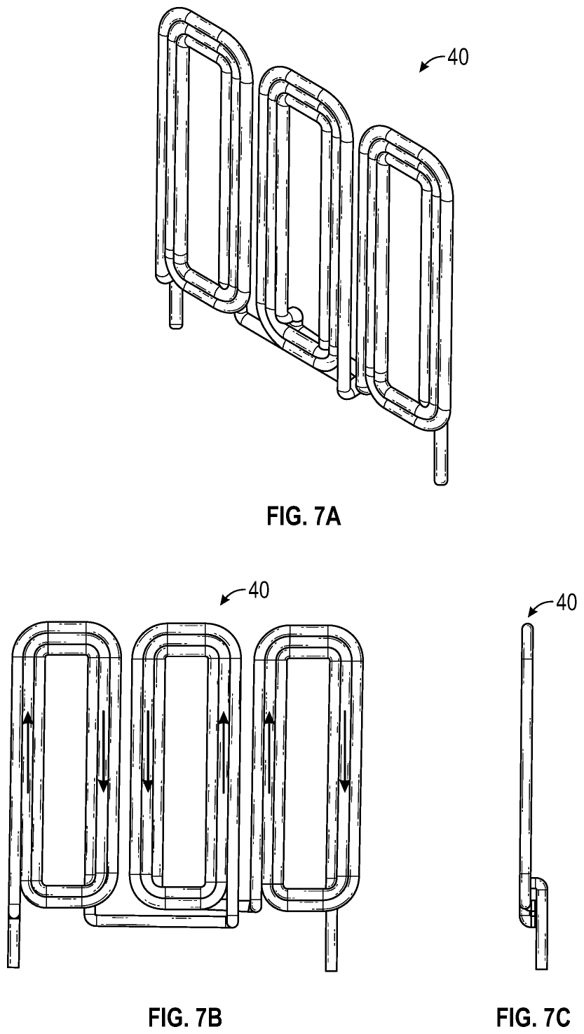

The multi-leg transformer 10 includes an upper core 20 and a lower core 22, an upper bobbin portion 30 and a lower bobbin portion 32, a primary coil 40 and a secondary coil 42, and shunt material 50. FIGS. 6A-D show additional views of the lower core 22, FIGS. 6A-D show additional views of the upper bobbin portion 30, and FIGS. 7A-C show additional views of the primary coil 40. It will be appreciated that the upper core 20 and lower core 22 may be the same or similar, the upper bobbin portion 30 and the lower bobbin portion 32 may be the same or similar, and the primary coil 40 and secondary coil 42 may be the same or similar.

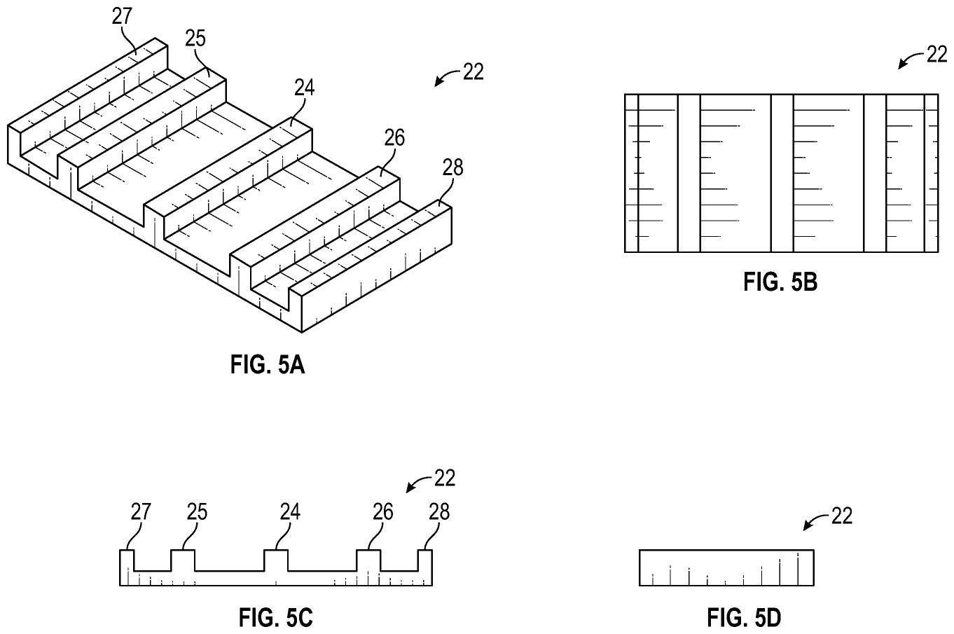

In an example embodiment of the multi-leg transformer 10, the upper and lower cores 20,22 form a multi-leg e-e or e-I core style structure having multiple center posts 24,25,26 and outer posts 27,28 (shown in FIGS. 5A-D). However, it will be appreciated that cores having any number of core or center posts greater than one may be employed. It will also be appreciated that the center posts 24,25,26 may have any shape, for example and without limitation, rounds, square, oblong, rectangular, or other shapes without departing from the scope of the disclosed concept. The primary coil 40 is wound around the center posts of the upper core 20 and the secondary coil 42 is wound around the center posts of the lower core 22, although it will be appreciated that the primary and secondary coils 40,42 may be switched without departing from the scope of the disclosed concept. It will also be appreciated that the primary and secondary coils 40,42 may be wound around any number of the center or outer posts without departing from the scope of the disclosed concept. The upper and lower bobbin portions 30,32 are structured to facilitate the winding and placing of the primary and secondary coils 40,42 around their corresponding core posts.

In an example embodiment, the multi-leg transformer 10 is structured such that the primary and secondary coils 40,42 are flat windings that are spaced apart. However, it will be appreciated that the primary and secondary coils 40,42 windings may be varied without departing from the scope of the disclosed concept. For example and without limitation, the windings may be single-layer or multi-layer. The primary and/or second coils 40,42 may each have single or multiple windings. In embodiments with multiple windings, the windings may be connected in series or in parallel for added design flexibility. Furthermore, each winding may be any of a variety of conductor styles such as, for example and without limitation, copper foils, LITZ wire, or any other suitable conductor style. It will also be appreciated that the windings may be single strand or multi-strand without departing from the scope of the disclosed concept. In example embodiments of the disclosed concept, shunt material 50 may be disposed in selected portions of the space between the primary and secondary coils 40,42. The shunt material 50 may be, for example and without limitation, a magnetic shunt material such as, for example and without limitation, ferrite material or powdered iron alloy. In some example embodiments, the shunt material 50 may be a plate of material. The selected portions where shunt material is disposed may be selected to tune characteristics of the multi-leg transformer 10 such as leakage inductance. That is, the shunt material 50 may be disposed in more or less of the volume between the primary and secondary coils 40,42 to tune the leakage inductance of the multi-leg transformer 10 to a desired level. Tuning of the leakage inductance is useful in transformer application such as, for example and without limitation, transformers used in LLC converters. Additionally, by being able to tune the leakage inductance via the shunt material 50, a separate resonant inductor to control the leakage inductance element within the LLC circuit is not needed.

In some example embodiments, the multi-leg transformer 10 has a low profile with, for example, short core legs and flat windings. The low profile enables better cooling by, for example, providing greater core surface area for better cold plate cooling. Improved cooling is useful in higher power applications. In some example embodiments, the multi-leg transformer 10 may be employed in, for example and without limitation, 1-22 kW, and in some example embodiment in 4-7 kW applications. In some example embodiments, the multi-leg transformer 10 may be employed in a LLC converter, but it will be appreciated that the multi-leg transformer 10 may be employed in other applications such as, without limitation, battery charging applications, as a distribution transformer stepping down voltages in large scale server applications, or in other applications.

In some example embodiments, the gap between core legs is minimal so that any fringing flux is limited to a smaller area and allows for only limited interaction with the windings of the primary and secondary coils 40,42.

In some example embodiments, the windings of the primary and secondary coils 40,42 are flat windings of, for example and without limitation, solid or LITZ wire. In some example embodiments, flat windings minimize proximity effect losses and allow for good coupling between the primary and secondary coils 40,42. The windings may be made in series such that a winding around a core leg and an immediately adjacent winding around a neighboring core leg have current flowing in the same direction, as is shown by arrows denoting current flow in FIG. 7B. Current flowing the same direction in immediately adjacent windings causes the flux generated by the currents to cancel out. In example embodiments, to facilitate immediately adjacent windings having current flowing in the same direction, the transition from one winding to an immediately adjacent winding will have a wire going from an outside edge of one winding to the inside edge of the adjacent winding, as is shown for example in FIG. 7B. In some example embodiments, to facilitate isolation of winding transitions and prevent shorting under high voltage conditions, the bobbin may include features to route and isolate the wires in transition from one winding to another from each other.

In some example embodiments, the primary and secondary coils 40,42 are wound in a similar manner, but it will be appreciated that they may be wound differently. It will be appreciated that the primary and secondary coils 40,42 may have the same or different numbers of turns. The primary and secondary coils 40,42 may be configured in a matrix such that the windings around each post may be connected in series or parallel depending on voltage and current requirements. In some example embodiments, the primary and secondary coils 40,42 may be further be configured as tapped windings to allow for the use of lower voltage rated switching devices. In some example embodiments, the primary and secondary coils 40,42 may or may not be molded to allow for better heat transfer and increased voltage isolation.

It will be appreciated that the bobbin may be formed from any number of portions without departing from the scope of the disclosed concept. For example, while upper and lower bobbin portions 30,32 are shown in an example embodiment, it will be appreciated that the upper and lower bobbin portions 30,32 may be combined, or further split in various ways into any number of bobbin portions. The upper and lower bobbin portions 30,32 each include center portions corresponding to the center posts 24,25,26. Each coil of the primary and secondary coils 40,42 are wound around one of the center portions.

In some example embodiments, the upper and lower bobbin portions 30,32 may include one or more capture features that may assist in keeping the primary and secondary coils 40,42 flat and in an essentially spiral shape around each of the posts. An example of a capture feature 34 is shown in FIG. 6C. The capture feature 34 may be, for example and without limitation, a shaped notch.

In some example embodiments, the upper and lower bobbin portions 30,32 may further contain an insulating barrier between the coils in the center to increase the turn to turn isolation voltage of the outer most turns in each coil.

In some example embodiments of the disclosed concept, the shunt material 50 is varied by thickness, width, and/or length to tune the leakage inductance of the multi-leg transformer 10. The shunt material 50 may be located in any or all of the spaces between the core center posts and/or outside core legs.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A multi-leg transformer comprising:
a core having a plurality of center posts;
a primary coil wound around at least one of the center posts;
a secondary coil wound around at least one of the center posts and spaced apart from the primary coil; and
at least one magnetic shunt material disposed in one or more selected areas between the primary coil and the secondary coil.

2. The multi-leg transformer of claim 1, wherein the at least one magnetic shunt material includes a plurality of pieces of magnetic shunt material.

3. The multi-leg transformer of claim 2, wherein the plurality of pieces of shunt material include different types of magnetic shunt materials.

4. The multi-leg transformer of claim 1, wherein at least one magnetic shunt material is composed of at least one of ferrite material and iron alloy.

5. The multi-leg transformer of claim 1, wherein one or more selected areas are selected to tune leakage inductance of the multi-leg transformer.

6. The multi-leg transformer of claim 1, wherein the core is a multi-part core.

7. The multi-leg transformer of claim 6, wherein the multi-part core includes an upper core and a lower core, wherein one of the primary coil and the secondary coil is wound around center posts of the upper core, and wherein the other of the primary coil and the secondary coil is wound around center posts of the lower core.

8. The multi-leg transformer of claim 1, further comprising:
a first bobbin structured to facilitate winding and placing of the primary coil; and
a second bobbin structured to facilitate winding and placing of the secondary coil.

9. The multi-leg transformer of claim 8, wherein at least one of the upper bobbin and the lower bobbin includes at least one capture feature structured to assist the primary coil or secondary coil retain shape around the center posts. The multi-leg transformer of claim 8, wherein at least one of the upper bobbin and the lower bobbin include an insulating barrier structured to provide insulation between coils of the primary coil or the secondary coil.

11. The multi-leg transformer of claim 1, wherein at least one of the primary coil and the secondary coil have flat windings.

12. The multi-leg transformer of claim 1, wherein at least one of the primary coil and secondary coil have windings structured such that current flowing through a first winding around a first center post and current flowing through an immediately adjacent winding around an adjacent second center post are in the same direction.

13. The multi-leg transformer of claim 1, wherein at least one of the primary coil and the secondary coil have tapped windings.

14. The multi-leg transformer of claim 1, wherein at least one of the primary coil and the secondary coil have windings of solid or LITZ wire. A method of making a multi-leg transformer, the method comprising:
providing a core having one or more core legs, a primary coil wound around at least one of the core legs, and a secondary coil wound around at least one of the core legs and spaced apart from the primary coil;
determining a desired level of leakage inductance of the multi-leg transformer; and
tuning the multi-leg transformer to the desired level of leakage inductance by placing at least one magnetic shunt material in one or more selected areas between the primary coil and the secondary coil.

16. The method of claim 15, wherein the at least one magnetic shunt material includes a plurality of pieces of magnetic shunt material.

17. The method of claim 16, wherein the plurality of pieces of shunt material include different types of magnetic shunt materials.

18. The method of claim 15, wherein the at least one magnetic shunt material is composed of at least one of ferrite material and iron alloy.

19. The method of claim 15, wherein tuning the multi-leg transformer includes selecting one or more of the location, volume, and type of the at least one magnetic shunt material.

20. A bobbin for a multi-leg transformer having a core having a plurality of center posts, a primary coil wound around at least one of the center posts, a secondary coil wound around at least one of the center posts and spaced apart from the primary coil, and at least one magnetic shunt material disposed in one or more selected areas between the primary coil and the secondary coil, the bobbin comprising:
a plurality of center portions corresponding to the plurality of center posts, each center portion structured to have a coil of the primary coil or secondary coil wound around it;
at least one insulating barrier disposed between two of the plurality of center posts and structured to provide insulation between coils of the primary coil or the secondary coil; and
at least one capture feature structured to assist the primary coil or secondary coil retain shape around the center posts.
